(19) United States
(12) Patent Application Publication
(10) Pub. No.: US 2005/0275372 A1
(43) Pub. Date: Dec. 15, 2005

(54) Power controller for managing arrays of smart battery packs

(76) Inventor: Jonathan C. Crowell, Dorchester, MA (US)

Correspondence Address: Norma E. Henderson, Esq.;Hinckley, Allen & Snyder LLP, 2nd Floor, 43 North Main Street, Concord, NH, 03301-4934, US

(21) Appl. No.: 11/151,991

(22) Filed: Jun. 14, 2005

Related U.S. Application Data
(60) Provisional application No. 60/579,409, filed on Jun. 14, 2004.

(51) Int. Cl. H02J 7/00

(52) U.S. Cl. 320/112

(57) ABSTRACT

A power controller combines a multitude of smart battery packs into a single large bank, providing balanced charging and discharging. Battery packs are connected in parallel to form groups that may then be connected in series, while the specification limits for current and voltage of individual packs are maintained through microprocessor control of the battery pack charging circuits. The state of each pack is monitored, and charging of a pack at too high a charge is inhibited until the other packs in the group are sufficiently charged to allow balanced current-sharing. The state of each battery is broadcast on a bus to all processors so that each may determine whether there are enough packs of similar charge to safely source a load. The system preferably incorporates management firmware that allows user monitoring of the status of the power subsystem and all connected battery packs.

### RELATED APPLICATION

This application claims priority to U.S. Provisional Application Ser. No. 60/579,409, filed Jun. 14, 2004, which is herein incorporated by reference in its entirety.

### FIELD OF THE INVENTION

The invention relates to power controllers and, in particular, to power management of arrays of battery packs.

### BACKGROUND

Today's typical Lithium-ion (Li-ion) battery packs, which are comprised of groupings of series and parallel cells with electronics, have strict specifications that limit the voltages and currents during charge and discharge in order to guarantee the safety of the cells and interconnecting wires and circuits. In many cases, the battery packs are required to have safety circuits that act as fuses to enforce these limits and thereby avoid unsafe conditions. The maximum current allowed to be sourced by these packs can be quite low, typically 2-6 Amps for a Li-ion battery pack. For transport reasons, the maximum number of cells that can be combined in a battery pack is often limited by the amount of Lithium permitted in each pack. This may be as low as 100 Watt-hours' worth.

Combining these battery packs into larger banks presents several problems. The parallel connection of battery packs needs to be done in such a way that the load sharing is balanced, in order to avoid exceeding the maximum current allowed per pack. The Li-ion packs cannot simply be wired in parallel to keep them charging at a similar rate, as is done with older battery chemistries such as lead acid. In the case of Li-ion battery packs, each one has separate charge circuit and diode isolation. The connection of these packs in parallel (through diodes) to a load therefore requires that the packs have similar charge states in order for current sharing to be matched. If more than one battery pack is tied together through diodes and connected to a load, the battery packs with the higher charge state will source more of the current. In the extreme, a single battery will try to source all of the current to the load. If the charge state is just 10% higher in one pack, it could be enough for it to be the only current source into the load. If the current of an individual pack is too high, the safety circuit in the pack will open up, removing this battery pack from the circuit. The next higher potential pack would then have to take over sourcing the load and could subsequently fail, causing a chain reaction throughout the group of packs.

In individual Li-ion battery packs, the parallel cells are shorted together so that their charge states are balanced by the fact that they are provided with equal charge voltages during the charge ramp and with natural current sharing on discharge. Unlike individual cells, the packs cannot be tied together directly, so some other means of keeping the charge states similar must be devised.

In the case when battery packs are not matched, a variable voltage drop can be added in series in order to put the higher charge state packs in balance before they are connected to a load. This prevents the battery pack with a much higher charge state from trying to service all of the current to a load, causing a specification violation and therefore a potential safety problem or fault. In this method, the balancing of the output current is accomplished by adding a variable voltage in series with each pack output. This voltage may be controlled so that the packs with a higher state of charge would have a higher voltage while supplying the load. The current will tend to balance due to the fact that the higher current pack will develop a higher series voltage inline with the battery voltage as the current increases, allowing the lower charge state batteries to source more current. If this series resistance is increased, the natural balancing is better at a cost of IR loss in the wire. This wastes power in the form of heat, even if the batteries are in balance.

What has been needed, therefore, is a power controller that can effectively manage a group of battery packs with separate charge circuits in order to bring the packs to similar charge states as quickly as possible.

### SUMMARY

The present invention is a controller that combines a multitude of smart battery packs into a single large bank, providing balanced charging and discharging. The invention connects the battery packs into parallel arrangements and the parallel-connected groups of battery packs into series arrangements, while still maintaining the strict specification limits for current and voltage of the individual packs during charge and discharge. The parallel connection of the battery packs into groups provides greater capacity and a greater maximum current potential, while the series connection of the battery pack groups increases the terminal voltage. The state of each pack is monitored, and a pack that is at too high a charge is isolated from its parallel group, charging of the pack being suppressed until the other packs are charged to a level sufficient to allow balanced current-sharing. This eliminates the specification limit issues of the prior art and allows for scaling of the power and capacity of the group of battery packs.

The present invention employs a multitude of charging circuits and a communication means for sharing the state information of each battery pack with all of the processors that control the charging circuits. The battery packs are combined through parallel and/or series connections of the output terminals and the charge process is synchronized over a multitude of independent battery chargers and batteries. The process of the present invention makes use of the ability to measure the charge state, current, voltage, and temperature of each individual battery pack. In a preferred embodiment, smart battery packs are used, as they provide all of this data in real time over a two-wire bus back to the controller. The present invention uses a means to switch each individual battery into and out of the parallel group that sources a load. If certain batteries will cause an imbalance, they can be left out of the active group in the parallel connection. The system broadcasts the state of each battery on a bus to all of the processors controlling each battery and its corresponding switches and chargers. Each processor determines whether there are enough packs of similar charge to safely source a load. The processor can also use switched series resistance in the path between each battery pack and the load in order to allow a battery pack to be used to help source the load, putting the system into a safe operating region while waiting for the charge states to become balanced. This allows the system to operate correctly, i.e. in specification, if it is necessary to switch from charge to discharge before the battery packs are brought into balance, such as may occur when a battery pack is replaced or an additional pack is added. Each cycle, offsets may be adjusted to bring the packs into a better balance in the next charge cycle, i.e. strong packs may be forced to lag in charge, weaker packs may be allowed to lead and move ahead in charge. Another option, besides adding series resistors, is to switch out the higher charge state batteries during the discharge cycle if they will cause an imbalance and specification violation.

An example embodiment of a system according to the present invention is comprised of 32 battery packs and 16 LT1760 charger circuits, with four microprocessors controlling them. In this example, two parallel groups of 16 battery packs are connected in series to provide twice the voltage to the load. Each group of 16 packs is charged as a separate group. The two groups may he moderated to keep the two series groups in lockstep charge, so that they have similar group capacities.

The system of the present invention preferably incorporates management firmware that can either operate autonomously or can communicate with a host system via an RS-232 bus or other suitable communications port or device. An embodiment incorporating this feature allows user monitoring of the status of the power subsystem and all of the battery packs connected to the system. In a preferred embodiment, the utility can display the state of the battery system, remaining capacity, current, voltage, amp-hours, percent of charge remaining, run time to empty, time to full charge, and other useful data on a pack-by-pack basis. In one embodiment, a controller screen displays the operating parameters of each of the controllers in the system, including total current, average pack voltage, and average pack temperature and a summary screen displays the overall state of an intelligent battery power system supporting a battery pack cluster.

### BRIEF DESCRIPTION OF THE DRAWINGS

FIG. 1 is a block diagram of one aspect of an example embodiment of the present invention, having eight isolated battery packs connected in a parallel configuration and controlled by a single microprocessor;

FIG. 2 is a block diagram of another aspect of an example embodiment of the present invention, having four 8-battery pack groups according to FIG. 1 connected in a parallel configuration;

FIG. 3 is a set of current plots for an embodiment of the present invention having four battery packs driving a resistive load;

FIG. 4 is a graph of the Reported Pack Capacity, while sourcing a load, for the embodiment of FIG. 3;

FIG. 5 is a graph of the Terminal Voltage of the four battery packs for the embodiment of FIGS. 3 and 4;

FIG. 6 is a diagram of a base battery management module of an example embodiment of the present invention, charging four battery packs;

FIG. 7 is a diagram of a typical application setup using the example embodiment of FIG. 6;

FIGS. 8A, 8B, and 8C are top, side, and end views, respectively, of a circuit diagram of an example embodiment of a base battery management module according to an aspect of the present invention;

FIGS. 9A and 9B are perspective and side views, respectively, of an example embodiment of a high current battery management stack according to an aspect of the present invention, including a base battery management module and an expansion module;

FIGS. 9C, 9D, and 9E are top, side, and end views, respectively, of a circuit diagram of an example embodiment of the base battery management module of FIGS. 9A and 9B;

FIGS. 9F, 9G, and 9H are top, side, and end views, respectively, of a circuit diagram of an example embodiment of the expansion module of FIGS. 9A and 9B;

FIGS. 10A, 10B, and 10C are top, side, and end views, respectively, of a circuit diagram of an example embodiment of a charge balance module with four controllers according to an aspect of the present invention;

FIG. 11 is a screen shot of an example embodiment of a summary screen produced by an embodiment of a management utility according to one aspect of the present invention;

FIG. 12 is a screen shot of an example embodiment of a controller screen produced by an embodiment of a management utility according to one aspect of the present invention; and

FIG. 13 is a screen shot of an example embodiment of a screen showing data for 5 each individual battery pack on a single 8-battery controller, as produced by an embodiment of a management utility according to one aspect of the present invention.

### DETAILED DESCRIPTION

The present invention is a controller for combining a multitude of battery packs, in order to provide balanced charging and discharging. The invention is a method and apparatus that allow the connection multiple smart battery packs into parallel and/or series arrangements, while still maintaining the strict specification limits for current and voltage of the individual packs during charge and discharge.

In the present invention, the parallel connection of the battery packs into groups provides increased power and capacity (watt-hours) and a greater maximum current potential, while series connection of these battery groups increases the available terminal voltage. The present invention provides a way to connect and manage these battery packs as a single large bank, maintaining the charge state, current, and voltage of each pack while charging so that the charge state of each pack remains matched, in order to ensure balanced current-sharing during discharge. The state of each pack is monitored, with packs that are at too high a charge being removed from the parallel group, thereby suppressing charging until the other packs are charged to a level sufficient to allow balanced current-sharing. Through use of a multitude of charging circuits and a communication means for sharing the state information of each battery pack with all of the processors that control the charging circuits, the present invention eliminates the specification limit safety issues of the prior art and permits efficient scaling of the power and capacity of the group of battery packs.

In the present invention, battery packs are combined through parallel and/or series connections of the output terminals and the charge process is then synchronized over all the independent battery chargers and battery packs. The system of the invention combines a multitude of smart battery packs in a parallel arrangement in order to provide greater current than is possible with a single pack, while controlling the charging and discharging of the packs so as to guarantee that current will be shared between'the battery packs such that no pack will exceed its maximum current sourcing specification. The invention also provides for these parallel groups to then be connected in series, in order to provide a greater output voltage and an increased power delivery.

The process of the present invention depends on the ability to measure the charge state, current, voltage, and temperature from each individual battery pack. In a preferred embodiment, smart battery packs are used, as they provide all of this data in real time over a two-wire bus back to the controller. These packs, such as the TI BQ2060, frequently also provide gas gauge chips that can report an accurate measure of the current charge of the battery pack.

A primary object of the present invention is to control the charge process in order to bring the charge of the packs to a similar current sourcing potential. The remaining charge reported by the battery packs is a good first approximation of the control variable for this current sourcing potential. In practice, the actual control variable is somewhat offset from this value in order to account for the differences in the battery packs' “strength” due to chemical differences or interconnect resistances. This difference can be reported as a table that gives an offset to the charge remaining as a function of charge. This information can be learned during the normal charge discharge cycles, or during a learning cycle wherein the battery bank is discharged into a test load, the current imbalance is measured, and the offsets are approximated. If a pack is providing a significantly higher share of the current, its offset to “remaining charge” will be reduced, signaling the servo loop to keep the pack at a lower charge point. If the initial current share of a pack is significantly lower than the average, then its offset will be increased. This process guarantees that when the battery pack goes from Charging to Discharging mode, the current charging is balanced so as to not exceed the specifications of any pack and to not wear out one pack more than an other by drawing current at a higher rate.

In some cases, the particular application may require each of the series connected groups to have similar remaining capacity, in order to ensure that the series stack discharge time isn't limited by a single parallel group, since the current required from each parallel group is equal. The system of the present invention can compare the state of charge between each of the battery packs in a given parallel arrangement to those in the other parallel arrangements that are series connected, in order to see if some groups have significantly more charge.

An object of the present invention is to be able to bring a group of battery packs with separate charge circuits to similar charge states as quickly as possible. It is assumed that, during the charge cycle, the batteries are not providing current to the load. The present invention brings the lower charge state packs up to a higher charge state while suppressing charging of the packs at a higher charge state. This allows the system to come into balance quickly and to be ready to be switched into a mode that can provide a sufficiently balanced current to provide the required maximum current of the load, which is usually many times more than a single pack can provide. In a preferred embodiment, the invention depends on each battery pack having a fuel gauge that can report the charge state of each pack. In addition, the current, voltage, and temperature of each pack are also preferably provided.

During the charge cycle, the control processors servo the charge inhibit of any pack that is charging faster than the group. This allows the slower charging battery packs to remain in the grouping while keeping a balanced charge. It therefore acts to move the packs together, keeping the charge rates in lockstep as the packs go from discharge to charge. If the packs are all in the group, then they can be switched from charge mode to discharge mode at any point in the cycle before they are all fully charged and the system will still current share well, allowing the system to provide a maximum current to the load. If the chargers were all independent, then the pack charge rates could all be quite different and the system might become unsafe to operate.

Tables 1 and 2 depict the load sharing when 8 battery packs are switched into a load (8 Amps@14.4V). Table 1 shows what happens when the charge states are different by 10%, while Table 2 shows what happens when the charge states are balanced.

TABLE 1

| | Pack1 | Pack2 | Pack3 | Pack4 | Pack5 | Pack6 | Pack7 | Pack8 |
|---|---|---|---|---|---|---|---|---|
| % charged | 90% | 80% | 90% | 80% | 90% | 80% | 90% | 80% |
| Current(amps) | 2.1 A | 0 A | 2.0 A | 0 A | 1.9 A | 0 A | 2.0 A | 0 A |

TABLE 2

| | Pack1 | Pack2 | Pack3 | Pack4 | Pack5 | Pack6 | Pack7 | Pack8 |
|---|---|---|---|---|---|---|---|---|
| % charged | 90% | 90% | 90% | 90% | 90% | 90% | 90% | 90% |
| Current(amps) | 1.0 A | 0.95 A | 1 A | 1.05 A | 0.94 A | 1 A | 1 A | 1.06 A |

As seen in Table 1, if the charge state of some packs is lower by just 10%, the voltage isn't sufficient to overcome the diode drop and allow those packs to source current. However, if the series resistance of the path from the battery to the load is high enough, then the battery packs driving higher current will eventually provide a lower voltage due to the IR drop, so they will start sharing (although still out of balance). In any case, there will always be some cells that can provide a greater share of the current, either because the cells are stronger or because they have less of a natural series resistance.

The present invention uses a means to switch each individual battery into the parallel group that sources the load. If certain batteries will cause an imbalance, they can be left out of the active group in the parallel connection. The system broadcasts the state of each battery on a bus to all of the processors controlling each battery and its corresponding switches and chargers. Each processor can then determine whether there are enough packs of similar charge to safely source a load. It can also use switched series resistance in the path between each battery pack and the load in order to allow a battery pack to be used to help source the load and put the system into a safe operating region while it is waiting for the charge states to become balanced. This allows the system to operate correctly in specification if it is necessary to switch from charge to discharge before the battery packs are brought into balance. In general this is a rare event, as the packs will stay in balance over the subsequent charge and discharge cycles once they are brought into balance for the first time. The exception to this is when a battery pack is replaced or an additional pack is added, as the charge state of the new battery pack is unsynchronized to the parallel bank being managed.

A feature of the present invention is that an offset to the target charge state can be added for each pack. This allows a stronger battery pack to be kept at a lower charge state, in order that the discharge imbalance is minimized across the complete discharge cycle. Optimally, this offset is learned, either by operating the system or in some conditioning discharge cycle. Each cycle, the offsets may be adjusted to bring the packs into a better balance in the next charge cycle, i.e. strong packs may be forced to lag in charge, weaker packs may be allowed to lead and move ahead in charge. The offset to the reported charge state for an equal discharge can be learned during a normal discharge, improved (iterated) each cycle, or can be learned in a controlled discharge cycle to an internal test load. This offset accounts for differences in battery strength/aging and differences in serial resistances of the complete interconnect network for each battery pack to the parallel connection.

Another option, besides adding series resistors, is to switch out the higher charge state batteries in the discharge cycle if they will cause an imbalance and specification violation. The goal is to remove the top “n” packs if there is a larger group of packs with similar charge state that are able to handle supplying the load current. However, there may be cases where there are not enough battery packs with significantly similar charge states to drive the load current until the charge process brings enough packs into sync. Without these added series resistance components, the system may then have to be stopped from sourcing current to a load until such time as the system has enough battery packs in balance.

In the case of series connection of battery packs in order to provide a higher voltage, care must be taken to not exceed the maximum voltage allowed across the packs' terminals, as it could damage the safety circuits. This would happen if a fault developed in one of the series connected groups and it was forced to open circuit. In this case, the remaining series connected battery banks' voltage could be applied across the terminals of the open pack, exceeding the maximum voltage and possibly damaging the safety circuit.

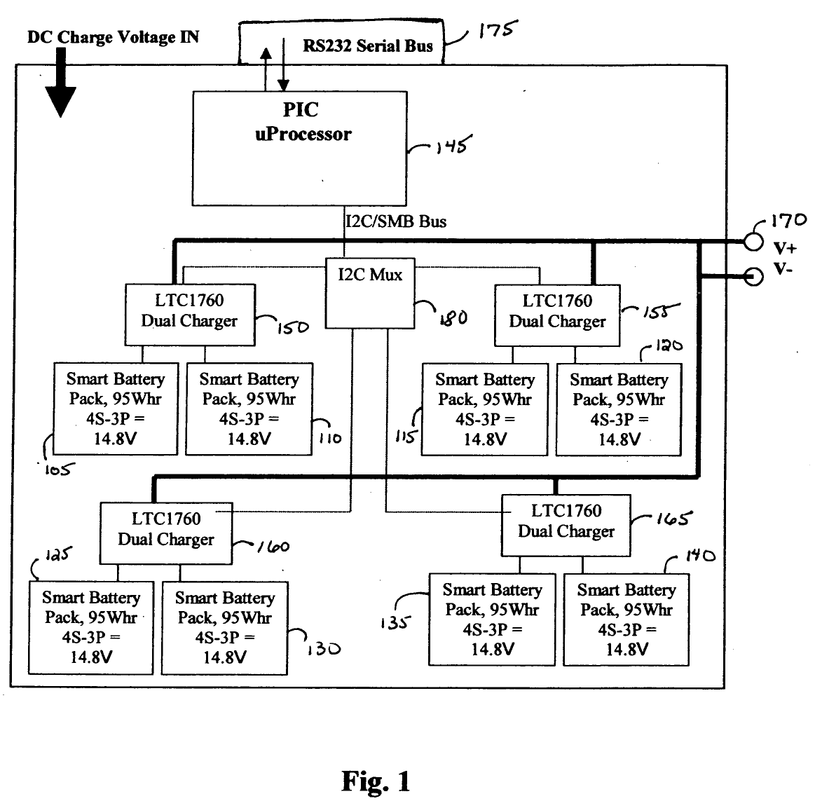

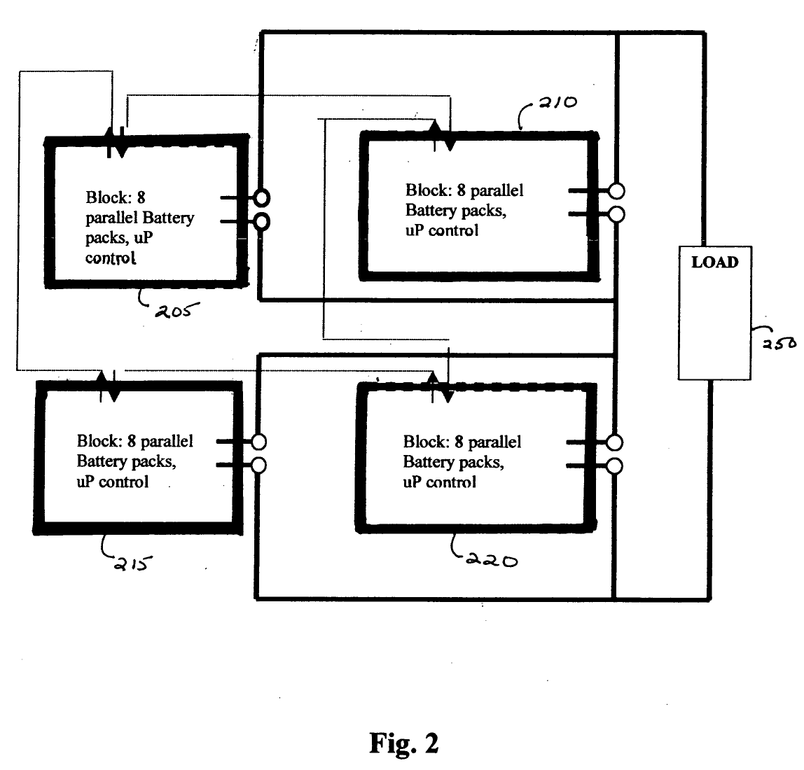

FIGS. 1 and 2 depict example block diagrams of an example embodiment of a system according to the present invention, comprised of 32 battery packs and 16 LT1760 charger circuits, with four microprocessors controlling them. In this example, two parallel groups of 16 battery packs are connected in series to provide twice the voltage to the load. In this case, each group of 16 packs is charged as a separate group. The two groups may also be moderated in order to keep the two series groups in some form of lockstep charge so that they have similar group capacities.

FIG. 1 depicts the parallel configuration of 8 isolated battery packs 105, 110, 115, 120, 125, 130, 135, 140, controlled by single microprocessor 145 and charged by dual charger circuits 150, 155, 160, 165. The output of each battery pack is connected to (V+) 170 through a PFET acting as a diode. The RS232 serial bus 175 talks to microprocessor 145 and all eight of batteries 105, 110, 115, 120, 125, 130, 135, 140 through multiplexor (MUX) 180.

FIG. 2 depicts four 8-battery pack configurations 205, 210, 215, 220 according to FIG. 1, connected in series in order to source load 250. Each configuration 205, 210, 215, 220 represents a configuration according to FIG. 1. The block diagram of FIG. 2 therefore depicts a configuration that has 32 batteries, configured 16 in parallel, in series with 16 more in parallel. If, for example, the base configuration of FIG. 1 has 14.8V nominal battery output, then the configuration of FIG. 2 has 29.6V nominal battery output.

The RS232 bus is connected in a loop so that the microprocessors can transmit and repeat messages to share data and commands. In this configuration, each local microprocessor controls the charging synchronization of each battery in its group. This is a distributed configuration, wherein each processor manages the local chargers and battery state. If the system broadcasts the measured state variables for each battery pack, the method can be run on each microprocessor with 8 battery packs and servo them to keep the charge state in balance during charging. There does not need to be any coordination between the processors, except for the requirement of knowing the maximum current required by the system when it goes into discharge mode.

Many commercially available smart battery packs with fuel gauge circuits provide some key control parameters that may be used in the management of the battery packs in the bank. These parameters may include current from the pack, terminal voltage, charge state (percent and Amp-hours remaining), and temperature. Examples of suitable battery packs and fuel gauge chips include the Inspired Energy NL2024 Rechargeable Smart Lithium Ion Battery Pack and the Texas Instruments BQ2060 Multi-Chemistry SBS 1.1 Compliant Gas Gauge, but any suitable battery pack and/or fuel gauge known in the art may be employed.

The current commercial smart battery charger chips will allow up to two batteries to be charged and selected in a parallel group with a connection to share all of the data with a control processor via a serial bus (I2C). The currently preferred embodiment of this invention uses the Linear Technology LTC1760 Dual Smart Battery System Manager as a charger and selector. In general, any battery charger chip could be used, so long as the battery pack state information (current, voltage, charge state, temp) can be read and an internal or external way to inhibit and resume the charge cycle exists or can be provided.

The LTC1760 chip allows a system controller to read the information from each battery pack using the I2C and an internal mux, in order to allow selection of which of the two packs to communicate with. It provides a control bit to stop charging both of the packs. It does have a deficiency, whereby charging of the packs cannot be individually inhibited. This feature is needed by this invention, and is accomplished in one embodiment by adding a small external circuit to signal the LTC1760 to stop the charging of a single pack. The easiest way to accomplish this is to provide the Thermistor pin with a value signaling an over-temperature indication on the pack. This inhibits charging until the temperature is back in range. Alternatively, the control processor may control the input to the LTC1760 using a simple digital circuit. There are other alternatives, readily apparent to one of ordinary skill in the art, which allow disconnection of an individual battery pack from sourcing the load. This ability is particularly needed in cases where a new battery pack has been put into the system and its charge state is too high compared to the other packs in its parallel group. It is also important to switch out a pack that is too weak or is otherwise defective in some way that means that it can't meet the requirements.

The LTC1760 does not provide any way to control the sharing of current between the two batteries that it connects to the load using a PFET switch. The higher voltage source will therefore supply the load. It is assumed that a single battery pack can supply the maximum required current to the load if the charge states are not balanced. It is worth noting that the LTC1760 will charge each pack at its own natural rate and that, at the end of the charge cycle, the packs will be at the same charge state. If a switch is made from charging to discharging mode at any time before the end of the charge cycle, the charge state of each pack could be significantly different. This imbalance will force the majority of the current to be sourced from one of the packs.

Since the charger sources the load using a PFET output (diode-like), many of these charger outputs may be connected together to put a multitude of battery packs in parallel. This presents a larger problem, wherein all of the battery packs can be at different points in the relative state of charge. If the parallel arrangement is moved to discharge mode before the charge cycle terminates, the situation may arise wherein one or a small number of packs is at a higher voltage and sources much of the load, exceeding the maximum allowed discharge current of one or more packs and consequently causing a safety issue with a pack and/or possible failure.

The following example algorithm, shown in Table 3, is used for controlling one parallel bank of battery packs. It scans to find out whether there are the minimum number of batteries with a similar charge (within PQ percent) that can adequately power the load. If the answer is yes, it starts all of the batteries in that list charging, as well as any with a lower charge. The batteries with a higher charge will not be charged until they are in the group of the first ‘RP’ (required packs) when looking from highest charge to lowest charge. In the following example algorithm:
Number of packs in a parallel group: NP (16 for this example)
Maximum current available from each battery pack: IB (4 Amps for this example)
Maximum current required by the load: IL (16 Amps for this example)
Charge difference of batteries in sync: PQ ((0.05) for this example)
Charge of a given pack: Q(B) (Initial charge given in table below)

ChargeOffset: This is the amount of charge needed to offset the battery packs charge reading in order to improve the balance.

TABLE 3

RP=roundup(IL/IB)
For x=1 to np

Q(x)=charge of pack x + ChargeOffset(x)
Pack(x)=x ! array of pack address, used after sorting

Sort array on q(i), [pack(i),q(i)] in descending order ! Stronger
packs first in the

list.

Packsready=0
for x=1 to NP

count=0
for n=x+1 to NP

if (q(x)−q(n))/q(n) < PQ then

Count=count+1

next n
if count>packsready then

packsready=count ! packsready is the largest group within
top=x

end if

if packsready>=RP then

exit for ! Leave for loop

next x
for x=1 to NP

if x< top then

turn_off_charge(pack(x))
limit_discharge(pack(x))

else

turn_on_charge(pack(x))
allow_discharge(pack(x))

end if

next x
if packsready>=RP then

turn_on_charge(pack(top))

end if

The example algorithm of Table 3 is a basic algorithm that can be extended in several ways, including:
1) A more complicated higher granularity function for Offset to charge can be used.
2) The turn_off_charge( ) function can be extended to allow some discrete or linear limiting of current on the packs that would otherwise source too much current.
3) Predictions on how much current will be sourced from the group of packs in the switched-on group may be added.

When the system is discharging, the current curves for each pack are monitored. The charge state when the current reaches its asymptote is used to see if the offset should be increased or decreased. The charge offsets can be selected to meet different goals. For example,
1) Highly balanced discharge curves. In this method, weaker batteries start higher and end at the lower current, so that it is balanced around the average. This yields the highest allowed current draw over the complete curve but may limit the full charge of some of the stronger battery packs; or
2) Balanced. In this method, the system gets the highest charge of each cell and still stays within the current specifications of each pack during discharge. This reduces the maximum current draw but allows more watt-hours to be stored in the battery bank.

Table 4 depicts the results of execution of the example algorithm on a set of readings over several points in time. As time increases, the charge state of the batteries that are turned on for charge increases. The loop finds the first NP=8 packs that are within PQ=0.10 (10%) charge of each other. The second set of columns is the data sorted. At time=0, packs 3, 10, 11, and 1 (italic) are those that have too high a charge state to be used if the bank has to be switched into discharge mode. The group containing packs 4, 14, 7, 13, 9, 6, 16, and 15 (bold) is the first group of battery packs within 10% that has at least eight members in the set. The charge value in the table is the offset charge. This is the charge remaining reported by the pack, adjusted by the pack's learned offset.

In Table 4, the group at time=30 shows the calculation of percent difference. It stops when it finds eight members in the set. It can be seen that the lower charge state battery packs charge faster and join the group. The last data set, at time=50, shows that all packs can now be used in discharge. Only one battery pack is more than 10% out of range. The value for RP (required packs) is a previously derived value based on measurements of the system in order to determine the difference in charge that may be tolerated and still allow a pack to contribute to sourcing current to the load. This is calculated as RP=roundup(IL/P), where IP is the minimum current a pack will contribute to the load when the charge difference is PQ percent different. As an example, IP may be 3 Amps when the spec limit is 6 Amps. The de-rating is due to the fact that the maximum current of the stronger pack with a higher charge will limit the pack at the lower end of the range.

TABLE 4
PQ = 0.10 10% difference in capacity′ = Q + offset
RP = 8 Minimum of 8 batteries needed in group

| | |
|---|---|
| Time = 0 | Time = 10 |

| | Capacity′ | sorted | Capacity′ | | | Capacity′ | sorted | Capacity′ | |
|---|---|---|---|---|---|---|---|---|---|
| Bat1 | 4567 | Bat3 | 5212 | | Bat1 | 4567 | Bat3 | 5212 | |
| Bat2 | 3200 | Bat10 | 5000 | | Bat2 | 3520 | Bat10 | 5000 | |
| Bat3 | 5212 | Bat11 | 4700 | | Bat3 | 5212 | Bat11 | 4700 | |
| Bat4 | 3600 | Bat1 | 4567 | | Bat4 | 3960 | Bat1 | 4567 | |
| Bat5 | 2100 | Bat4 | 3600 | 0% | Bat5 | 2730 | Bat4 | 3960 | 0% |
| Bat6 | 3500 | Bat14 | 3600 | 0% | Bat6 | 3850 | Bat14 | 3960 | 0% |
| Bat7 | 3550 | Bat7 | 3550 | 1% | Bat7 | 3905 | Bat7 | 3905 | 1% |
| Bat8 | 3460 | Bat13 | 3543 | 2% | Bat8 | 3841 | Bat13 | 3897 | 2% |
| Bat9 | 3520 | Bat9 | 3520 | 2% | Bat9 | 3590 | Bat6 | 3850 | 3% |
| Bat10 | 5000 | Bat6 | 3500 | 3% | Bat10 | 5000 | Bat15 | 3849 | 3% |
| Bat11 | 4700 | Bat16 | 3500 | 3% | Bat11 | 4700 | Bat8 | 3841 | 3% |
| Bat12 | 2500 | Bat15 | 3499 | 3% | Bat12 | 2775 | Bat9 | 3590 | 9% |
| Bat13 | 3543 | Bat8 | 3460 | 4% | Bat13 | 3897 | Bat2 | 3520 | 11% |
| Bat14 | 3600 | Bat2 | 3200 | 11% | Bat14 | 3960 | Bat16 | 3500 | 12% |
| Bat15 | 3499 | Bat12 | 2500 | 31% | Bat15 | 3849 | Bat12 | 2775 | 30% |
| Bat16 | 3500 | Bat5 | 2100 | 42% | Bat16 | 3500 | Bat5 | 2730 | 31% |

| Time = 20 | | | | | Time = 30 | | | | Calculations to find the first | | |
|---|---|---|---|---|---|---|---|---|---|---|---|
| | Capacity′ | sorted | Capacity′ | | | Capacity′ | sorted | Capacity′ | group of > 8 within 10% capacity | | |
| Bat1 | 4567 | Bat3 | 5212 | | Bat1 | 4567 | Bat3 | 5212 | 0% | | |
| Bat2 | 3680 | Bat10 | 5000 | | Bat2 | 4048 | Bat10 | 5000 | 4% | 0% | |
| Bat3 | 5212 | Bat11 | 4700 | | Bat3 | 5212 | Bat11 | 4700 | 10% | 6% | 0% |
| Bat4 | 3960 | Bat1 | 4567 | | Bat4 | 4316 | Bat13 | 4677 | 10% | 6% | 0% |
| Bat5 | 2730 | Bat4 | 3960 | 0% | Bat5 | 3549 | Bat15 | 4619 | 11% | 8% | 2% |
| Bat6 | 3850 | Bat14 | 3960 | 0% | Bat6 | 4235 | Bat1 | 4567 | 12% | 9% | 3% |
| Bat7 | 3905 | Bat7 | 3905 | 1% | Bat7 | 4335 | Bat14 | 4356 | 16% | 13% | 7% |
| Bat8 | 3841 | Bat13 | 3897 | 2% | Bat8 | 4301 | Bat7 | 4335 | 17% | 13% | 8% |
| Bat9 | 3590 | Bat6 | 3850 | 3% | Bat9 | 3949 | Bat4 | 4316 | 17% | 14% | 8% |
| Bat10 | 5000 | Bat15 | 3849 | 3% | Bat10 | 5000 | Bat8 | 4301 | 17% | 14% | 8% |
| Bat11 | 4700 | Bat8 | 3841 | 3% | Bat11 | 4700 | Bat6 | 4235 | 19% | 15% | 10% |
| Bat12 | 2775 | Bat2 | 3680 | 7% | Bat12 | 3608 | Bat2 | 4048 | 22% | 19% | 14% |
| Bat13 | 3897 | Bat9 | 3590 | 9% | Bat13 | 4677 | Bat9 | 3949 | 24% | 21% | 16% |
| Bat14 | 3960 | Bat16 | 3500 | 12% | Bat14 | 4356 | Bat16 | 3850 | 26% | 23% | 18% |
| Bat15 | 3849 | Bat12 | 2775 | 30% | Bat15 | 4619 | Bat12 | 3608 | 31% | 28% | 23% |
| Bat16 | 3500 | Bat5 | 2730 | 31% | Bat16 | 3850 | Bat5 | 3549 | 32% | 29% | 24% |

| | |
|---|---|
| Time = 40 | Time = 50 |

| | Capacity′ | sorted | Capacity′ | | | Capacity′ | sorted | Capacity′ | |
|---|---|---|---|---|---|---|---|---|---|
| Bat1 | 5024 | Bat15 | 5542 | | Bat1 | 5526 | Bat6 | 5641 | 0% |
| Bat2 | 4453 | Bat3 | 5212 | 0% | Bat2 | 5343 | Bat13 | 5555 | 2% |
| Bat3 | 5212 | Bat13 | 5191 | 0% | Bat3 | 5525 | Bat15 | 5542 | 2% |
| Bat4 | 4748 | Bat11 | 5170 | 1% | Bat4 | 5318 | Bat11 | 5532 | 2% |
| Bat5 | 4259 | Bat1 | 5024 | 4% | Bat5 | 5111 | Bat1 | 5526 | 2% |
| Bat6 | 4701 | Bat10 | 5000 | 4% | Bat6 | 5641 | Bat3 | 5525 | 2% |
| Bat7 | 4811 | Bat14 | 4835 | 7% | Bat7 | 5292 | Bat10 | 5500 | 2% |
| Bat8 | 4775 | Bat7 | 4811 | 8% | Bat8 | 5252 | Bat2 | 5343 | 5% |
| Bat9 | 4344 | Bat8 | 4775 | 8% | Bat9 | 4778 | Bat4 | 5318 | 6% |
| Bat10 | 5000 | Bat4 | 4748 | 9% | Bat10 | 5500 | Bat7 | 5292 | 6% |
| Bat11 | 5170 | Bat6 | 4701 | 10% | Bat11 | 5532 | Bat8 | 5252 | 7% |
| Bat12 | 4329 | Bat2 | 4453 | 15% | Bat12 | 5195 | Bat12 | 5195 | 8% |
| Bat13 | 5191 | Bat9 | 4344 | 17% | Bat13 | 5555 | Bat5 | 5111 | 9% |
| Bat14 | 4835 | Bat12 | 4329 | 17% | Bat14 | 5077 | Bat16 | 5082 | 10% |
| Bat15 | 5542 | Bat5 | 4259 | 18% | Bat15 | 5542 | Bat14 | 5077 | 10% |
| Bat16 | 4235 | Bat16 | 4235 | 19% | Bat16 | 5082 | Bat9 | 4778 | 15% |

Charge Off, current limit if discharge
Charge on, full on if discharge
Charge on, limited current if discharge

The LTC1760 will automatically switch from charging to sourcing the load when the DC charge voltage IN is removed, unless the output is disabled. If the calculations show that the battery packs are not sufficiently in balance to supply the required load, these can all be switched off until the packs servo together to a point at which they can source the load.

The intellegent battery controller of the present invention can optionally report the results of the calculations (Maximum Current Possible) up to the system that generates the load, in order that the system can also know when it is safe to source the load from the parallel arrangement. The controllers can also remove batteries that are operating at current aproaching maximum or switch in a series resistance to balance it out on the discharge. The need for this is usually due to some fault condition, as the system normally behaves very well because the discharge is very predictiable if the batteries are charged to similar states.

In an experiment employing an example embodiment system having 32 battery packs, the load sharing kept the currents within 10% through the cycle. With packs with 3 Amps, 16 in parallel, the maximum discharge provided to a load was about 43 Amps without exceeding the 3 Amp spec of any cell. In practice, a much larger derating would be used, say 50%. In the 32 battery pack example, this would allow operation and sourcing of 24 Amps@28.8V, about 690 Watts. While the example shows a system with 32 battery packs, 2 groups of 16 in parallel connected in series, the present invention is clearly scalable to any size, both larger and smaller. For example, another example configuration uses 8 controllers in parallel, each with 8 battery packs, 6 Amps max current each. At a 50% derating, this allows sourcing of a load of 192 Amps@14.4V, 2754 Watts.

Another benefit of these massively parallel battery packs is that they can reduce the current that any one battery pack delivers. The usable capacity of the battery packs is extended as the discharge rate is lowered. If the example system is drawing 20 Amps, the load on each pack is about 0.3 Amps or 0.04C (6.6 Ahr/pack). The packs' capacity is given at a discharge rate of 0.2C; this lower rate will increase the pack's usable capacity significantly.

Without the present invention's provision for allowing the chargers to operate independently, during charge and discharge cycles imbalances can be seen that can limit the peak current that can be safely sourced to just a small fraction of the peak load available when the batteries are kept in lockstep on charging. This could be a factor of 20× less, or even greater, on large systems that are switched from charging to discharging at an arbitrary point in the charge cycle, although it will be less if the packs are allowed to fully charge.

The present invention uses the individual battery state measured from the onboard electronics, shared among all of the controlling processors, in order to manage the charge and discharge of each independent battery, charger, and discharge multiplier. The decision on how to manage the charge of each battery can be made by a multitude of processors, so long as they can read the data from each battery pack in the same parallel group. The data from each battery can be broadcast between each processor on any bus structure, such as RS232, Ethernet, or in a single processor. The algorithms to keep the charge state fair in each battery pack as it is charging can therefore be distributed between any number of controlling processors or state machines. The algorithm that determines the maximum load current possible can be run from any processor.

The measured battery voltage is at its terminals. Knowing the voltage is equal at the point where the interconnect meets the load with a hardwired connection, along with the measured current for each battery, the series resistance can be calculated for each battery pack as R=v/I. The optional switched in series resistance added to each pack can either be a real resistor or an offset to the FETs gate that limits its current output. The standard mode of devices like the LTC1760 mux is to turn the FETs on like a switch. A bias can be added to the gate to choke off the current. This allows higher charge state batteries to share in sourcing the load and keeping the system in balance, where balance is the point at which the battery current is under its maximum load.

The charge offset that keeps the stronger battery packs at a lower charge state so they can share the load can optionally be replaced with an added current limit function. The system can monitor the current from each battery, determine that its share of the current is too high, and can take action to limit its current to keep the overall system safely providing the required current to the load without interruption, e.g. like a power grid.

The standard mode of these chargers allows a charging voltage to be provided that will charge the batteries and be fed out to provide the same current to the load, while the packs are charging, without interruption to the load current. The LTC1760 switches over in less than 10 us, a feature that can be utilized to provide very large currents to the load.

An added measurement of the adapter current may also be made, in order to balance the current being sourced to the load. The FETs that source the parallel connection can then be controlled by placing a bias voltage on the gates of the FETs, in order to limit the current if one battery is taking more than its share, thereby keeping the group of parts in balance and avoiding over-current situations.

One of the processors that control a group of battery packs can combine the data from all of the battery packs and provide a single set of data for the bank of batteries working as a group. This date may include, for example, total current sourced, remaining Amp-hours of capacity, percent, or remaining charge for the group. In the presently preferred embodiment, the serial buses are connected in a loop between the processors. Each processor can repeat the data received from a processor downstream and truncate the data that came from itself. In this way, each processor sees the data from the complete bank of battery packs. The host level reporting can occur via a different bus or the host can be in the loop, repeating data and accepting the composite data for itself.

The following experimental data and graphs were obtained using a battery controller that has four Li-ion smart battery packs in the device. It was sourcing a fixed resistive load. Measurements were reported every 2 seconds. The concepts scale to a very large number of battery packs in parallel sourcing a load. The sharing of the battery state data SMBus to shared bus and the ability to control each individual battery pack's charge are key to implementing large systems.

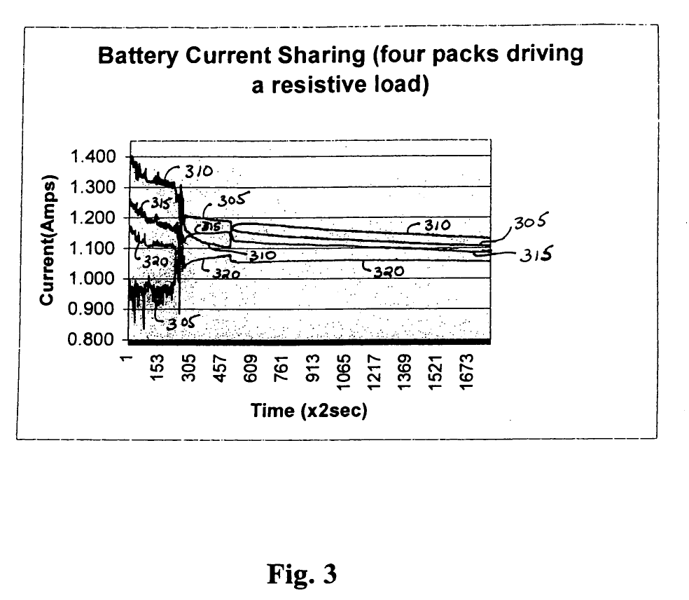

The three graphs of FIGS. 3, 4, and 5 were obtained using a configuration of the present invention wherein four battery packs were used to source the same load through a diode junction. FIG. 3 is a set of current plots for the four battery packs 305, 310, 315, 320 of this embodiment. At the initial time, battery pack 310 can source the most current, 1.4 Amps, while battery pack 305 can source the least, 0.96 Amps. This is still fairly well balanced, but over time the present invention caused battery packs 305, 310, 315, 320 to approach an asymptote and source the most balanced current, as shown at time 1784 (1 hour into the run). At this point, battery pack 310 has the highest current, 1.13 Amps, and battery pack 315 has the lowest, 1.06 Amps.

Initially, the difference in current between the highest and lowest packs is 45%. After the packs get closer to equilibrium (approximately 1 hour), the difference in current between the packs is only 7%. At this point, the reported pack capacity in milliamp-Hours is 3026 mAh for the highest value and 2914 mAh for the lowest pack. If the charging of the packs were adjusted to keep the packs' charge separated by this amount at this charge point, the discharge current would start off in balance at the 7% difference. Observation is made of the natural offsets between the packs' current, e.g. pack 310 and its associated cable plant can deliver 6% more current than pack 315, etc. The offset can be measured and then the packs selectively topped off in order to bring the amount of charge to a balanced starting point. Running a complete discharge curve allows development of a table of the capacity differences required to have balance for a set of capacity points. This curve can then be used during the charge process to throttle the charge on all the packs and keep them in very close balance. In this way, the system can be moved from the charge mode to the discharge mode anywhere in the charge cycle, yet still provide balanced current sharing.

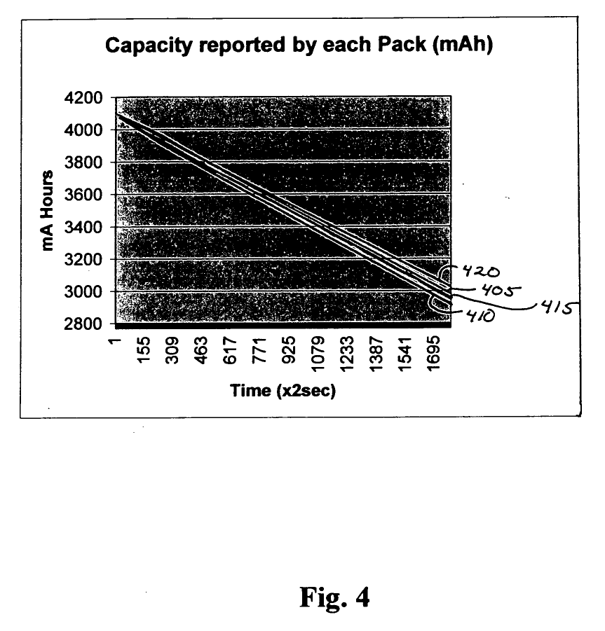

FIG. 4 is a graph of the Reported Pack Capacity 405, 410, 415, 420 of the four battery packs 305, 310, 315, 320, respectively, while sourcing the load for the embodiment of FIG. 3. If the four packs are allowed to charge independently, one pack may have 10% or more charge than the others during the process. If the system were put into discharge mode at that point, the battery 10% ahead of the others may naturally try to source all of the current until its charge decreases to a point where its pack voltage, under load and with IR drop across the cable plant, allows the other packs to start delivering current. The problem with this approach is that, in this case, the total current delivered into the load is 4.8 Amps initially. Since each pack is only allowed to source 3 Amps and they are fused, at 4 Amps the stronger pack would blow a fuse, destroying it. Even if a single pack were able to source the load without damage or a specification violation, that pack is heated more, has higher current draws, and thus will wear out quicker, decreasing its total charge and current sourcing characteristics.

Another observation is that it may not be desirable for all of the packs to be charged to the maximum amount reported on the fuel gauge in order to meet the balance points. The values are very close, so not too much capacity is given up by leaving some packs with a bit less charge. This difference in charge is accounted for by each pack's varying chemistry, differences in the resistance of the cables, connectors, FET switches, etc. Ideally, the physical plant should have similar resistances and similar voltage drops for the same current, but this is not necessary since these differences can be learned.

Another problem is that the fuel gauges drift, so that the learned values for capacity may have an error introduced in the readings. This is typically corrected by allowing the battery packs to go through a full discharge—full charge cycle and then re-calibrating. The present invention does not require this, as each discharge curve can provide updates to the data regarding where the balance points are relative to the reported capacity (fuel gauge reading). This learning also accommodates any changes in the physical cable plant resistance, as well as changes in the batteries' chemistry and ability to deliver current.

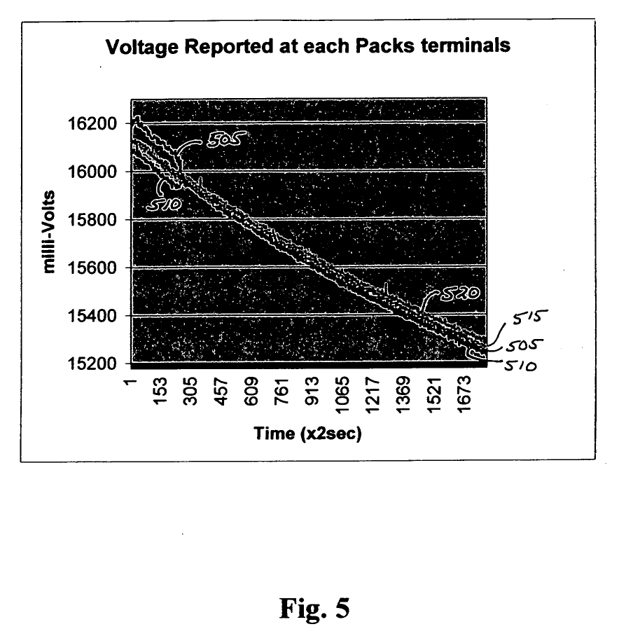

FIG. 5 is a graph of the Terminal Voltage 505, 510, 515, 520 of the four battery packs 305, 310, 315, 320, respectively, for the embodiment of FIGS. 3 and 4. In FIG. 5, it can be seen that the batteries that are sourcing a larger current report a lower voltage. This is due to the IR drop across the wiring plant and electronics. Since the voltage at the load is equal for each battery pack, the resistance of each current delivery path can be inferred from the current and voltage data. This information can be used for a health check of the system, in order to ensure that too much loss isn't occurring in the system due to a defective or shifting value component. If desired, a more complicated curve may be generated based on experimental or measured data for a given system. For example, the curve could be a function based on the charge state, voltage, and temperature of the complete set of battery packs.

A test was performed using the four-battery configuration used to generate FIGS. 3-5. As shown in Table 5, B(0) & B(1) have lower fuel gauge readings. They are sourcing 26% less current for the sum of the two batteries (“Branch current”), than B(2) & B(3). The difference in current between the weakest battery and the strongest is 65%.

TABLE 5

| | |
|---|---|
| Batteries Present: | 4 |
| Average Voltage: | 15.162 Volts |
| Currents: | |

B(0) = −0.77 A [2427] B(1) = −0.65 A [2418] Branch 1 Current: −1.43
B(2) = −0.95 A [2727] B(3) = −1.07 A [2784] Branch 2 Current: −2.03

| | |
|---|---|
| Branch 3 Current: | 0.00 |
| Branch 4 Current: | 0.00 |
| Average Current: | −0.865 Amps |
| Total Current: | −3.462 |
| ** Discharging ** | |
| Runtime to empty: | 183 min, 3.05 hours |

As shown in Table 6, the first two batteries were charged up to increase the reported capacity to above that of the second two batteries. The current is now higher in the first branch for those batteries that had charge added. This process can then be repeated until the point is found where the charge is nearly perfectly balanced and equal.

TABLE 6

| | |
|---|---|
| Batteries Present: | 4 |
| Average Voltage: | 15.313 Volts |
| Currents: | |

B(0) = −1.06 A [2761] B(1) = −0.88 A [2724] > Branch 1 Current: −1.94
B(2) = −0.72 A [2723] B(3) = −0.81 A [2779] > Branch 2 Current: −1.53

| | |
|---|---|
| Average Current: | −0.871 Amps |
| Total Current: | −3.486 |
| ** Discharging ** | |
| Runtime to empty: | 192 min, 3.19 hours |

A feature of the preferred embodiment of the present invention is that the current from each battery can be measured hundreds of times a second. In the above example, the firmware of the device is displaying this data with the branch current for two batteries. This is because, in this design, each pair of batteries shares a discharge path that can only handle 6 Amps. The firmware therefore can constantly monitor the currents, as well as other critical parameters, such as temperature, voltage, etc., and can take immediate action if an unsafe condition is forming. It is possible for a single branch current to be climbing toward the unsafe levels, in which case the system can introduce a resistance into the discharge path in order to slow the current or remove the battery from the group that is sourcing the load. If at any time the system will not be able to balance the currents safely, a signal is sent that will tell the load to stop drawing current. In the case of DC-DC converters, this would be the OFF pin, shedding the load and shutting down the system. This is what a laptop does when it has been run to the point where the batteries are too low.

The example above also shows the current Runtime to EMPTY. This is how long the batteries can source current at the present load value, in this case 3.486 Amps. This can be used by the system that is being powered for planning its operations and for preparing for the future EMPTY battery condition. It also allows devices like robots or underwater vehicles to monitor power consumption and then reduce power consumption in order to guarantee that they have enough power to complete the mission. For example, the correction required may be as simple as lowering the speed from 4 MPH to 3 MPH, saving a significant amount of power since the miles per watt increase.

The data discussed above is derived directly from the battery packs' reporting of TimetillEmpty. The battery controller uses this data, along with current, voltage, and capacity, in order to predict when the overall fuel will run out. A larger system having many packs in parallel needs to guarantee that there are enough packs sourcing current in balance in order to supply the load without exceeding the current limits of any components in the system. The firmware can use a flexible set of rules to make the decision on when to terminate system discharge and await a re-charge cycle.

Some examples:
(1) If the load current is under the current that one battery can draw, the system can deplete all batteries and, when the last battery reports as fully discharged, it can terminate system power.
(2) If the system has a high current draw, a threshold can be set so that, when “k” batteries have above “x” mAh of charge, the system can be operated, but below that point it must be shut down.
(3) The system can allow batteries to fully discharge until the point that, if “n” more batteries were removed from the pool sourcing current, it would cause an unsafe condition, after which it can shut down. Example: A system with 20 batteries, 10 being required to source the load, “n”=2. After the first 8 batteries reach “Fully Discharged”, the system will shut down.
   Further, the behavior of how shutdown is reached can be observed, and other algorithms may then be used to increase the depth of discharge without reaching an unsafe condition.

The present invention has been implemented in one embodiment as the OceanServer Technology, Inc. Intelligent Battery and Power System (IBPS). The IBPS allows designers to add smart rechargeable Li-Ion battery power as an OEM component to their computer, electronic equipment, or electromechanical designs. The IBPS serves as the regulated power supply, providing power from either an AC wall outlet or a bank of Li-Ion battery packs. This allows the system designer to easily create a portable or battery backed-up device using a pre-engineered power subsystem. If the AC wall power is lost or unplugged, the battery instantly switches in without interruption. This allows the powered equipment to be portable or to be securely running in battery back-up mode. When wall power is restored, the system reverts to AC power and simultaneously re-charges all of the attached battery packs. The IBPS utilizes the same safety circuitry found in laptop computers used in critical safety situations, such as commercial air travel.

The IBPS microprocessor continuously communicates with all of the attached smart battery packs in the system, managing charging and discharging, and responding to key events. The OceanServer Technology BB-04 Base Battery Management Module manages four battery packs, or eight battery packs by adding the Expansion Battery Management Module. This configuration can provide up to 800 Watt-hours of high density Li-Ion battery power for devices. The optional DC-DC Converter Module provides regulated DC power to an embedded system. The output is compatible with an ATX power supply for ease of use with off the shelf, low-cost computer components.

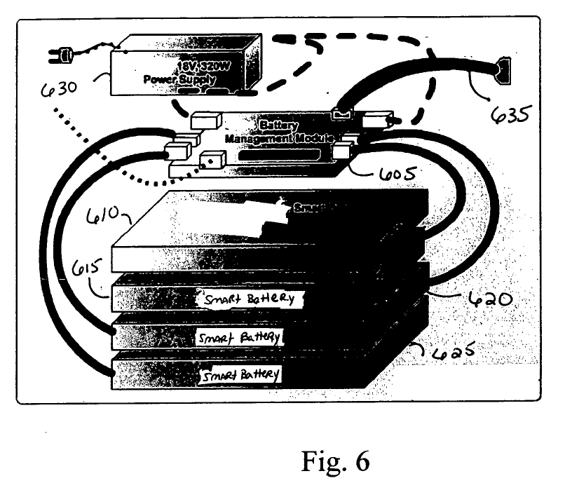

FIG. 6 is a diagram of a base battery management module of an example embodiment of the present invention, charging four smart battery packs. In FIG. 6, base battery management module 605 charges smart Li-ion battery packs 610, 615, 620, 625, is powered by power supply 630, and communicates with the host system through an RS232 port via communications cable 635. In a currently preferred implementation, base battery management module 605 is an OceanServer Technology BB-04 battery management module, smart battery packs 610, 615, 620, 625 are BA95HC-FL, 95 Whr, 14.4V, 6.6 Ahr smart battery packs, power supply 630 is a PS-320, 18V, 320W power supply, and host communications cable 635 is a DB9 communications cable.

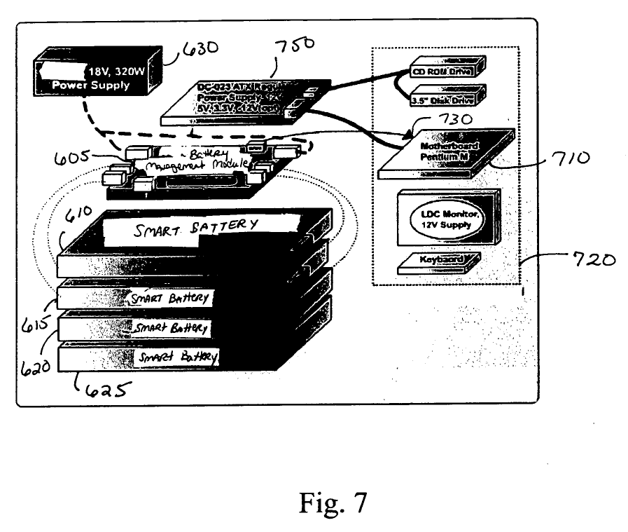

FIG. 7 is a diagram of a typical application setup using the example embodiment of FIG. 6. In FIG. 7, base battery management module 605 charges smart battery packs 610, 615, 620, 625, is powered by power supply 630, and communicates with motherboard 710 of user system 720 that is being powered through RS232 communications port 730. Use of regulated power supply 750 for converting battery or wall voltage into regulated DC for powering user system 720, such as an OceanServer Technology DC-023 ATX Regulated Power Supply, DC-DC Converter module, 12 V, 5V, 3.3V, −12V, is optional, depending on the system configuration. With four BA-95 battery packs, the typical host system will be able to run for between 12 and 20 hours on battery power when the charge voltage is removed.

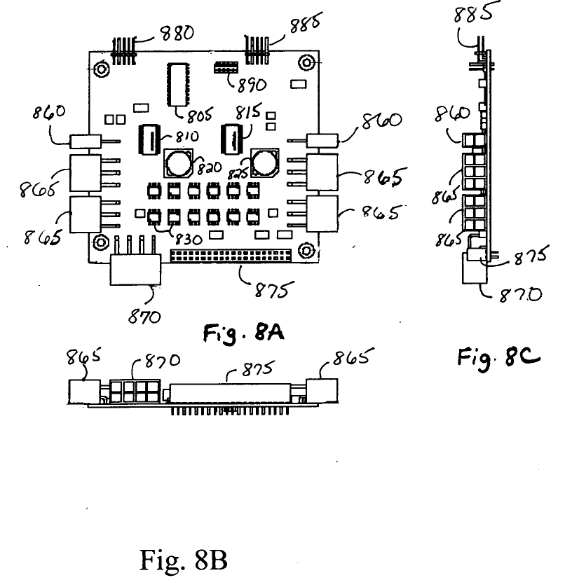

FIGS. 8A, 8B, and 8C are top, side, and end views, respectively, of a circuit diagram of an example embodiment of a base battery management module according to an aspect of the present invention. The module pictured is the OceanServer Technology BB-04 base battery management module. In FIGS. 8A, 8B, and 8C, PIC microprocessor 805 (18F258) manages the chargers on the base and expansion modules for up to 8 smart battery packs. Dual Smart Battery Charger chips 810, 815 (LTC1760) each control the charging and muxing of a set of two smart battery packs. Inductors 820, 825 are utilized for the DC-DC circuits for the charge circuits. FET transistors 830 are used to switch the battery and charge circuits into the load. These are used to provide diodes for merging the load sources that use perfect diode low resistance switches, if the voltage is such that positive current will flow. This reduces the diode losses substantially. DCIN Charge voltage supply 860 is 18-24V for the circuit shown. Connector 865 connects the board to a smart battery pack using 5 pins: V+, V−, SMB_DATA SMB_CLOCK, Tpin. System power output 870 provides the parallel output voltage that is hard wired between a multitude of modules to drive a common load (parallel connection). Internal bus 875 is used for connecting an expansion module that manages the second group of 4 batteries using PIC microprocessor 805. Control pins 880 provide switch input, signals out (ON OFF control). RS232 bus 885 is used for communicating data from these 1-8 battery packs up to the user or a higher-level processor for managing a larger group of processors.

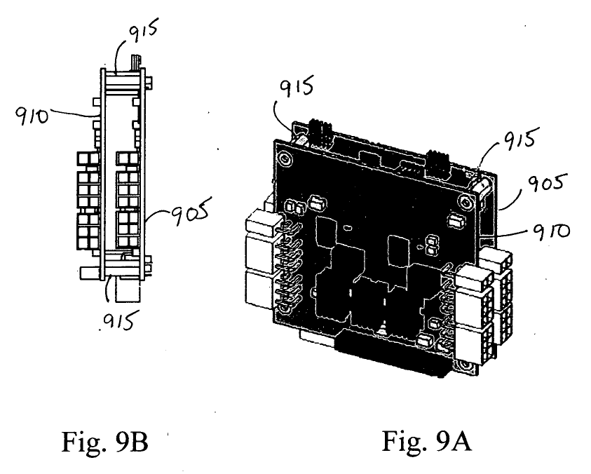

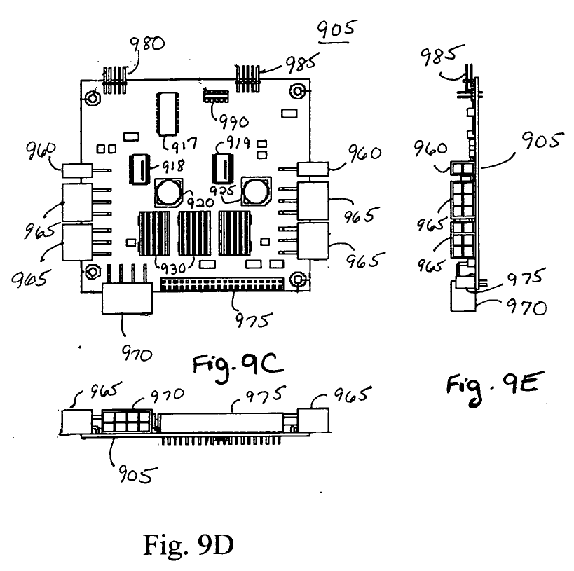

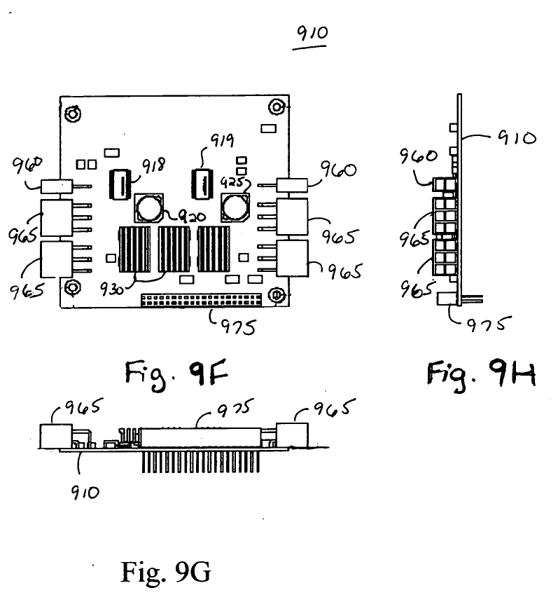

FIGS. 9A and 9B are perspective and side views, respectively, of an example embodiment of a high current battery management stack according to an aspect of the present invention, including base battery management module 905, top expansion module 910, and hex standoffs 915. The device pictured is the OceanServer Technology MP-08 high current battery management stack. In a currently preferred implementation, base battery management module 905 is an OceanServer Technology MP-08 high current base battery management module and expansion module 910 is an OceanServer Technology MP-08 high current top battery management module. Base module 905 has a PIC microprocessor that is used to control up to four LTC1760 chargers, 8 battery packs, on two modules. Expansion module 910 uses the microprocessor on base module 905, allowing allows the two module set to handle up to 8 smart battery packs.

FIGS. 9C, 9D, and 9E are top, side, and end views, respectively, of a circuit diagram of the base battery management module of FIGS. 9A and 9B. The high current base battery management module of FIGS. 9C, 9D, and 9E is similar to the base battery management module of module FIGS. 8A, 8B, and 8C, with heat sinks on the transistors and higher current transistors. In FIGS. 9C, 9D, and 9E, PIC microprocessor 917 manages the chargers on the base and expansion modules for up to 8 smart battery packs. Dual Smart Battery Charger chips 918, 919 (LTC1760) each control the charging and muxing of a set of two smart battery packs. Inductors 920, 925 are utilized for the DC-DC circuits for the charge circuits. FET transistors 930 are used to switch the battery and charge circuits into the load. These are used to provide diodes for merging the load sources that use perfect diode low resistance switches, if the voltage is such that positive current will flow. This reduces the diode losses substantially. DCIN Charge voltage supply 960 is 18-24V for the circuit shown. Connector 965 connects the board to a smart battery pack using 5 pins: V+, V−, SMB_DATA, SMB_CLOCK, Tpin. System power output 970 provides the parallel output voltage that is hard wired between a multitude of modules to drive a common load (parallel connection). Internal bus 975 is used for connecting an expansion module that manages the second group of 4 batteries using PIC microprocessor 905. Control pins 980 provide switch input, signals out (ON OFF control). RS232 bus 985 is used for communicating data from these 1-8 battery packs up to the user or a higher-level processor for managing a larger group of processors.

FIGS. 9F, 9G, and 9H are top, side, and end views, respectively, of a circuit diagram of the top expansion module of FIGS. 9A and 9B. Expansion module 910 uses the microprocessor 917 on base module 905. In FIGS. 9F, 9G, and 9H, PIC microprocessor 917 on base module 905 manages Dual Smart Battery Charger chips 918, 919 (LTC1760), which each control the charging and muxing of a set of two smart battery packs. Inductors 920, 925 are utilized for the DC-DC circuits for the charge circuits. FET transistors 930 are used to switch the battery and charge circuits into the load. These are used to provide diodes for merging the load sources that use perfect diode low resistance switches, if the voltage is such that positive current will flow. This reduces the diode losses substantially. DCIN Charge voltage supply 960 is 18-24V for the circuit shown. Connector 965 connects the board to a smart battery pack using 5 pins: V+, V−, SMB_DATA, SMB_CLOCK, Tpin. System power output 970 provides the parallel output voltage that is hard wired between a multitude of modules to drive a common load (parallel connection). Internal bus 975 is used for connecting an expansion module that manages the second group of 4 batteries using PIC microprocessor 905. Upward communication of data is performed utilizing RS232 bus 985 on base module 905.

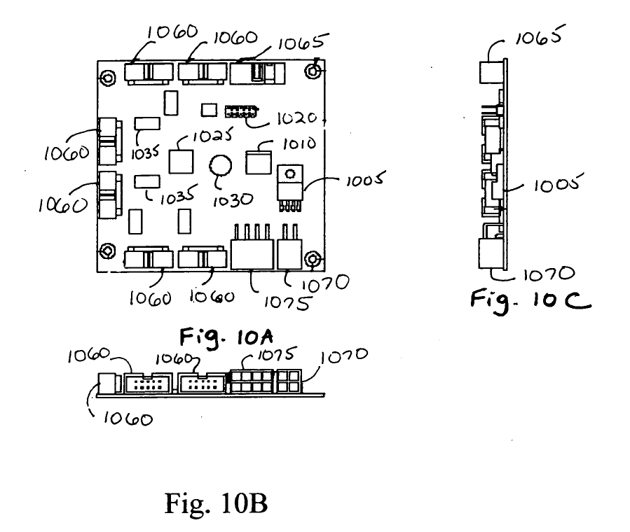

FIGS. 10A, 10B, and 10C are top, side, and end views, respectively, of a circuit diagram of an example embodiment of a charge balance module with four controllers according to an aspect of the present invention. This module serves as a combiner module, providing a PIC microprocessor that can communicate with up to four MP-08 controller, 4×8 smart battery packs (=32) battery packs. This module permits management of all 32 of the smart battery packs connected as a single array, balancing charge. In FIGS. 10A, 101B, and 10C, regulator 1005 produces the 5V required for microprocessor and UART operation. UARTs 1035 communicate with the MP-08 controllers or the higher-level host. These devices have 50V isolation for use in systems where the controllers may be put into serial arrangements where the corn signals could be offset by up to 50 Volts. Connectors 1060 (ComA, Com1, Com2, Com3, Com4) and IO 1065 permit connection to a host COMA or to a higher-level processor for managing larger groups than 32 battery packs. Com1-Com4 are connected to 8 battery controllers (MP-08). When this module is present, the MP-08 controllers act as slave devices, allowing the CB-04 to be the single point of control. Groups of CB-04's can be used, with COMA feeding the battery state data and receiving the charger control data from a higher-level processor. Input power ports 1070, 1075 provide unregulated or regulated power for operating the device.

The system of the present invention preferably incorporates management firmware that can either operate autonomously or can communicate with a host system via an RS-232 bus or other suitable communications port or device. The battery monitoring utility program of an embodiment incorporating this feature allows monitoring of the status of the power subsystem and all of the battery packs connected to the system. The utility can display the state of the battery system, remaining capacity (fuel gauge), current, voltage, amp-hours, percent of charge remaining, run time to empty, time to full charge, and other useful data on a pack-by-pack basis.

One currently preferred implementation of this utility is the OceanServer Technology MINIBATS software program, a Microsoft Windows™-based utility that runs on the target system, monitoring and displaying the status of the overall intelligent battery power system, all controllers, and each attached battery pack, and letting the user integrate the power system into a Windows™ environment. The MINIBATS utility allows the system to monitor the state of the battery system and then provides actions to take when the battery power is running low. For example, a user warning may be issued (e.g. “Power low, save your work”), a program or command file may be run when the battery capacity reaches a pre-specified threshold percentage, or a system shutdown or hibernation may be initiated in response to certain system conditions.

Another currently preferred implementation of the management utility is the OceanServer Technology FULLBATS program, which allows monitoring of the status of very large battery cluster systems. The FULLBATS software is a Windows™ GUI-based application that monitors a full battery system and logs the operating parameters while the battery cluster is operating. It allows production of CSV files that can be displayed in a spreadsheet or graphed on the screen in a strip chart while the program is operating. The FULLBATS program collects data via the serial port connections to the high power boards. The current embodiment of the software can support up to 16 controllers (up to 128 batteries), and is easily extendible by one of skill in the art to handle larger systems.

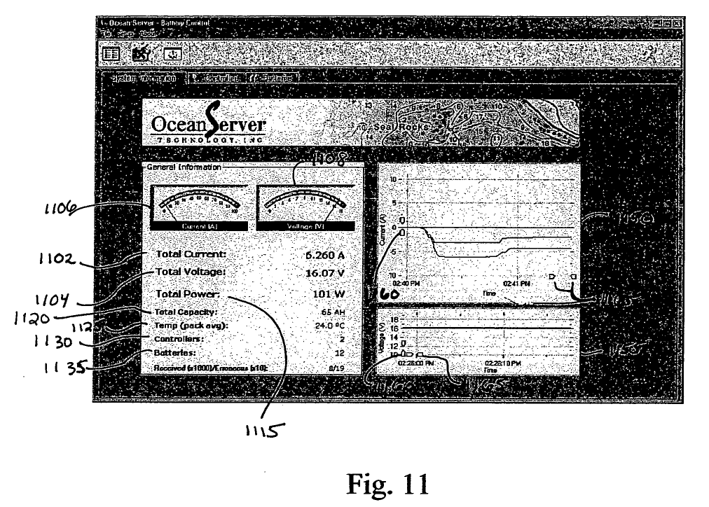

FIG. 11 is a screen shot of a summary screen produced by the OceanServer Technology FULLBATS management utility, summarizing the state of an intelligent battery power system supporting a 64 battery pack cluster. The screen shows parameters from an actual 6000 watt-hour battery cluster that is charging, using 2149 watts of charge voltage in a constant current charge mode at 16.18V average.

On the left side of the screenshot of FIG. 11, Total Current 1102 and Total Voltage 1104 are shown in the text and graphically on meters 1106, 1108. The current convention used is positive (+) when current is being supplied to the batteries (charging) and negative (−) when current is being sourced from the batteries (discharging). Below the current 1102 and voltage 1104 measurements in the text block are Total Power of the system 1115, Total Capacity 1120 (sum of the available capacity as reported from the battery pack in Amp Hours), average pack temperature 1125, number of IBPS Controller/Charger modules 1130 active in the system, and total number of batteries 1135 attached to the controllers under management. To the right side on the same screen are two active graphs that display current draw 1150 and voltage activity 1155 over time. This permits the user to quickly note any changes as the load is varied by the served system and to monitor high-level performance factors. These strip chart graphs can actively show different ranges of plotted data, varying in time and in amplitude. Left clicking the mouse on arrow tabs 1160 and sliding them permits changing the limits of the plot. Right clicking the mouse and dragging time 1165 along permits looking back in time at prior system operation.

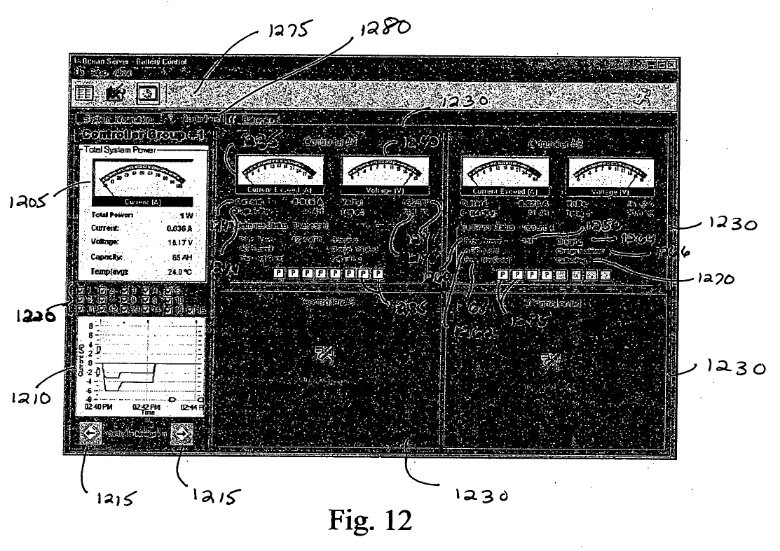

FIG. 12 is a screen shot of an example embodiment of a controller screen produced by the OceanServer Technology FULLBATS management utility according to an aspect of present invention, showing the state of all the controllers in the intelligent battery power system. The screen displays the operating parameters of each of the OceanServer Technology MP-08 controllers in the system. Total current, average pack voltage, and average pack temperature may be measured and the status of each pack on the controller can then be viewed.

The controller screen shows the status of each controller and a summary of the batteries attached. The left side of the screen displays current meter 1205 and graph 1210 for an entire controller group. The right side of the screen displays summaries for 4 individual controllers per page. By cycling through the pages using controller navigation buttons 1215, all the individual controllers can be viewed and monitored. Meter 1205 and its associated text values in the top left of the screen show the total values for the total system. Graph 1210 displays the total current of the batteries that are connected to the controller. Each controller's current is plotted on graph 1210. Above graph 1210 is a group of check boxes 1220, each next to a controller number. The current of each controller that has a check mark in a box 1220 next to it is displayed on graph 1210. Graph 1210 is effectively the same as graph 1150 on the main system level screen of FIG. 11. Again, the current convention used is positive (+) when current is being supplied to the batteries (charging) and negative (−) when current is being sourced from the batteries (discharging).

Each controller block 1230 on the right displays a current 1235 and voltage 1240 meter. Below meters 1235, 1240 are displayed the actual values of total current 1242, total capacity 1244, average voltage 1246, and average temperature 1248 for the batteries attached to the controller. Below the operating parameters of the controller is the status of the batteries that are attached to the controller. The numbers 1250 next to the six status lines indicate by number which battery pack is in the given state. The states are:

1. Providing Power 1260: When a battery pack's number is here, the battery pack is switched into the load path and is providing power or is ready to provide power to source the load.

2. AC Present 1262: When a battery pack's number is here, the charge DC 5 voltage, supplied from an AC adapter or power supply, is present and can be used to charge the battery pack. Charging occurs provided there is sufficient voltage and enough current available to both charge the batteries and source the load. The batteries are grouped in pairs and a charge voltage is applied to each battery pair separately.

3. Charging 1264: When a battery pack's number is here, it indicates that the battery is in the charge state and is being charged. When a battery reports that it is fully charged, it will not allow itself to be charged further.

4. Charge Inhibited 1266: The battery pack listed is inhibited from being charged. This can occur for the following reasons: the pack is fully charged already, the pack is over temperature, or there is a communications problem with respect to reading the battery pack's voltage, current, and temperature. If the controller cannot communicate with the battery pack, it is not safe to charge the pack.

5. Power No Good 1268: When a battery pack's number is here, there is a fault condition prohibiting the battery from being charged or discharged. The only way to clear this fault is to remove all power from the controller. This fault typically occurs in an over-current situation. This error message will flash in the top of the screen 1275 where the icons are located. When the controller tab 1280 is clicked, the battery that has set this condition is displayed. The circuit breaker opens the battery up from the circuit when it senses either an over-current condition for more than 10 ms from the controller or a short circuit voltage at the output of the controller (e.g. 14.4V drops below 3V). This condition should never happen in a properly designed system, so if this condition is displayed, then the system is drawing more current than is allowed from the controller or some failure is causing excessive current or a short.

6. Calibrating 1270: This indicates that the battery pack is in a calibration cycle. In general, the controller will not start calibration on a battery.

Below the status lines are small colored status blocks 1285 that contain a code that displays the state of each battery pack. There are 7 possible codes:

C=Charging. The battery pack is charging at >50 mA.

CR=Charge Ready. The battery pack is charging a 50 mA or less.

FC=Fully Charged. The battery pack has charge power present and the status of the battery pack is fully charged.

D=Discharging. The battery pack is discharging.

DR=Discharge Ready. The pack is discharging and the current is >−50 mA and <50 mA.

NG=Power Not Good. There has been an over-current status in the battery pack. The only way to clear this condition is to remove all power from the IBPS.

P=Present. The battery pack is present and not in any of the above states.

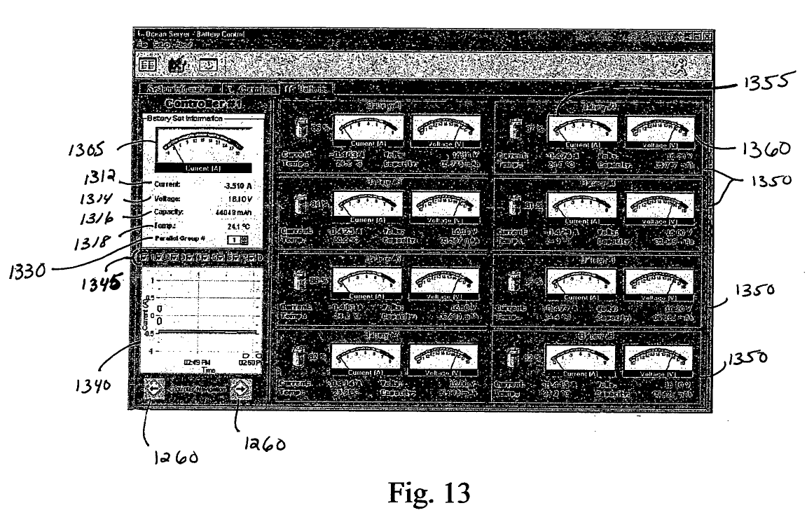

FIG. 13 is a screen shot of an example embodiment of a screen produced by the OceanServer Technology FULLBATS management utility, showing data for each individual battery pack on a single OceanServer Technology MP-08 8-battery controller. Via this screen, the packs report any alarms, terminal current, terminal voltage, and pack temperature, as measured inside the pack. This permits user verification that the system is operating correctly.

The Batteries screen of FIG. 13 shows the status of each of the smart battery packs in the controller group. It can be displayed graphically or in a text format. The graphic and text version of the Batteries screen has current meter 1305 and the actual current 1312, voltage 1314, capacity 1316, and temperature 1318 for the controller being displayed. Parallel group # 1330 is used in advanced systems that involve putting multiple controllers in serial in order to produce higher output voltages. Graph 1340 is an active plotting tool that shows the current draw on each battery plotted vs. time. Checkboxes 1345 are used to choose which batteries to plot. Again, the current convention used is positive (+) when current is being supplied to the batteries (charging) and negative (−) when current is being sourced from the batteries (discharging). The readings are taken at the terminals of the battery packs in order to get the maximum safe charge level and current, canceling out the negative effects of cable resistance and IR drop. In this embodiment, the screen displays the battery status in eight frames 1350, with graphical meters displaying current draw 1355 and voltage 1360 for each battery pack. The background color of current meter 1355 changes in order to indicate the current flow of the battery pack. In the present embodiment, yellow indicates charging, red indicates discharging, and black indicates low current. Controller navigation buttons 1260 permit viewing and monitoring of the individual batteries for all controllers.

The present invention therefore provides a power controller that can effectively manage a group of battery packs with separate charge circuits in order to bring the packs to similar charge states as quickly as possible, thereby preventing operation outside the system safe limits. Each of the various embodiments described and/or depicted above and in the following pages and accompanying drawings may be combined with other described embodiments in order to provide multiple features. Furthermore, while this section describes a number of separate embodiments of the apparatus and method of the present invention, what is described herein is merely illustrative of the application of the principles of the present invention. Other arrangements, methods, modifications, and substitutions by one of ordinary skill in the art are therefore also considered to be within the scope of the present invention.

1. A controller for managing at least one group of battery packs, comprising:
at least one charger circuit capable of charging at least one battery pack;
a plurality of battery packs connected in parallel to form a battery pack group, each battery pack being connected to a charger circuit; and
at least one processor able to receive at least one parameter associated with at least one battery pack and to manage the battery pack group by controlling the operation of the charger circuits.

2. The controller of claim 1, further comprising a second battery pack group connected in series with the battery pack group.

3. The controller of claim 1, further comprising a plurality of battery pack groups connected in series with the battery pack group.

4. The controller of claim 1, further comprising a communications device for communicating at least one parameter associated with the battery pack group to the controller.

5. The controller of claim 1, further comprising at least one switchable series resistance connected to at least one battery pack and controllable by the microprocessor.

6. The controller of claim 4, further comprising a management utility for receiving at least one parameter from the controller and communicating information associated with the controller to a user.

7. The controller of claim 2, further comprising a communications device for communicating at least one parameter associated with at least one battery pack group to the controller.

8. The controller of claim 2, further comprising at least one switchable series resistance connected to at least one battery pack and controllable by the microprocessor.

9. The controller of claim 7, further comprising a management utility for receiving at least one parameter from the controller and communicating information associated with the controller to a user.

10. The controller of claim 3, further comprising a communications device for communicating at least one parameter associated with at least one battery pack group to the controller.

11. The controller of claim 3, further comprising at least one switchable series resistance connected to at least one battery pack and controllable by the microprocessor.

12. The controller of claim 10, further comprising a management utility for receiving at least one parameter from the controller and communicating information associated with the controller to a user.

13. A method for managing groups of battery packs, comprising the steps of:
connecting a plurality of battery packs in parallel, forming at least one battery pack group;
connecting each battery pack in each battery pack group to a charger circuit capable of charging at least one battery pack; and
managing at least one battery pack group by receiving at least one parameter associated with at least one battery pack and controlling the operation of at least one charger circuit in response.

14. The method of claim 13, further including the steps of:
connecting at least two battery pack groups in series; and
managing the connected battery pack groups.

15. The method of claim 13, further including the step of communicating at least one parameter associated with at least one battery pack group to a controller.

16. The method of claim 14, further including the step of communicating at least one parameter associated with at least one battery pack group to a controller.

17. The method of claim 15, further comprising the step of communicating information associated with the controller to a user.

18. The method of claim 16, further comprising the step of communicating information associated with the controller to a user.

19. A method for increasing the current, capacity, and voltage that can be provided by a battery system, comprising the steps of:
providing at least two battery pack groups connected in series, each battery pack group comprising:
at least one charger circuit capable of charging at least one battery pack;
a plurality of battery packs connected in parallel to form a battery pack group, each battery pack being connected to a charger circuit; and
at least one processor able to receive at least one parameter associated with at least one battery pack and to manage the battery pack group by controlling the operation of the charger circuits; and
managing the connected battery pack groups to control a charge state, current, or voltage of at least one battery pack in the battery pack group.

20. The method of claim 19, further comprising the step of communicating at least one parameter associated with at least one battery pack group to a controller or user.
